(19) United States
(12) Patent Application Publication
(10) Pub. No.: US 2021/0215273 A1
(43) Pub. Date: Jul. 15, 2021

(54) SIDE BRACKET

(71) Applicant: SEUNG JIN IND. CO., LTD., Gyeonggi-Do (KR)

(72) Inventor: Woon Taek Jung, Gyeonggi-do (KR)

(21) Appl. No.: 17/144,797

(22) Filed: Jan. 8, 2021

(30) Foreign Application Priority Data
Jan. 13, 2020 (KR) 10-2020-0004036

(51) Int. Cl. F16L 3/10; F16M 13/02; A62C 35/68

(52) U.S. Cl. CPC F16L 3/1058; A62C 35/68; F16L 3/1075; F16M 13/027

(57) ABSTRACT

A side bracket is proposed. The side bracket includes: a lower side bracket disposed under a square bar and having an open structure formed opposite to a predetermined section of a rectangular section by bending both edge sections positioned around the predetermined section; a tightener disposed through the lower side bracket and opening or closing the open structure of the lower side bracket; an upper side bracket being formed as a rectangular pipe, surrounding the square bar, and rotating on the lower side bracket with respect to the predetermined section of the rectangular section; and a horizontal fastener and a vertical fastener being in contact with the square bar through a side and another side of the upper side bracket, respectively.

### CROSS REFERENCE TO RELATED APPLICATION

The present application claims priority to Korean Patent Application No. 10-2020-0004036, filed Jan. 13, 2020, the entire contents of which is incorporated herein for all purposes by this reference.

### BACKGROUND OF THE INVENTION

### Field of the Invention

The present disclosure relates to a side bracket disposed on a linear structure of a ceiling of a building and holding a square bar, which is combined with a reducer, across the reducer to stably suspend the reducer and a sprinkler head, which are sequentially disposed from a horizontal pipe of the ceiling, from the horizontal pipe.

### Description of the Related Art

In general, buildings have a plurality of floors, in which a horizontal pipe is installed each floor and a vertical pipe connects the horizontal pipes of adjacent floors. The vertical pipes are installed along the side walls of a building and send water to horizontal pipes. The horizontal pipe is installed in the ceiling of each floor and supplies water to the available water facility of each floor.

Accordingly, the horizontal pipe sequentially supplies water to a reducer and a sprinkler head through a new pipeline in consideration of the ceiling structure in the fireproof facility of the available water facility. The ceiling structure may be a T-grid ceiling type or a pipe ceiling type.

When the ceiling is finished in the T-grid ceiling type, a square bar is fixed to T-bars facing each other of four T-bars surrounding a rectangular area selected from the T-grid ceiling, and then the reducer is fixed to the square bar between the T-bars facing each other of the four T-bars.

When the ceiling is finished in the pipe ceiling type, a square bar is fixed to two pipes of a plurality of pipes in the pipe ceiling, and then the reducer is fixed to the square bar between the two pipes. The square bar may be fixed to an individual T-bar or an individual pipe with an annular center bracket fitted or may be fixed to an individual T-bar or an individual pipe and then fitted to a center bracket having a lock shape.

Further, the square bar is fixed to an individual T-bar or an individual pipe through a side bracket and the reducer is fixed to the square bar through a center bracket. Accordingly, the sprinkler head is fixed to the square bar through the reducer on the ceiling. However, since the side bracket is a single structure, the side bracket is positioned only to straightly face two T-bars or two pipes when supporting a square bar on the two T-bars or the two pipes.

Accordingly, the square bar is fixed to an individual side bracket through an individual side bracket, so the square bar cannot be installed obliquely with respect to the arrangement direction of the side brackets, on two T-bars or tow pipes. In order to appropriately divide spaces in each floor of the building, the ceiling structure is usually required to enable a square bar to be installed obliquely with respect to the direction in which a side bracket is disposed.

Unless the ceiling structure is changed, the shape of the square bar should be changed between adjacent side brackets straightly facing each other so that a reducer is fixed to the square bar. To this end, the square bar undergoes an additional machining process, which increases the installation cost of a sprinkler head. A technology similar to the side bracket has been disclosed in Korean Patent No. 10-1418791 in the related art.

### SUMMARY OF THE INVENTION

The present disclosure has been made in an effort to solve the problems in the related art and an objective of the present disclosure is to provide a side bracket, which is configured such that when the ceiling of a building is finished in a T-grid ceiling type or a pipe ceiling type, the side brackets are disposed on two T-bars or two pipes to face each other straightly or obliquely, thereby being suitable for freely determining the direction in which a square bar, which connects the two T-bars or two pipes to each other, is disposed.

In order to accomplish the above objective, the present disclosure provides a side bracket disposed on linear structures of a ceiling of a building and holding a square bar, which is combined with a reducer, across the reducer to stably suspend the reducer and a sprinkler head, which are sequentially disposed from a horizontal pipe of the ceiling, from the horizontal pipe, the side bracket including: a lower side bracket disposed under the square bar and having an open structure formed opposite to a predetermined section of a rectangular section by bending both edge sections positioned around the predetermined section; a tightener disposed through the lower side bracket and opening or closing the open structure of the lower side bracket; an upper side bracket being formed as a rectangular pipe, surrounding the square bar, and rotating on the lower side bracket with respect to the predetermined section of the rectangular section; and a horizontal fastener and a vertical fastener being in contact with the square bar through a side and another side of the upper side bracket, respectively, in which when the lower side brackets are disposed on two linear of the ceiling through the open structure, the lower side brackets face each other straightly or obliquely on the two linear structures; a connection hole is formed at the predetermined section of the rectangular section; the upper side bracket has a pipe body configured to surround the square bar in a rectangular shape, a rotary pipe integrally formed with the pipe body, inserted in the connection hole of the lower side bracket to be rotatably coupled to the connection hole of the lower side bracket, a horizontal hole formed perpendicular to the rotary pipe through a side of the pipe body and communicating with the rotary pipe through an inside of the pipe body, and a vertical hole formed through another side of the pipe body to straightly face the rotary pipe and communicating with the rotary pipe through the inside of the pipe body, wherein the upper side brackets face each other on the lower side brackets in an arrangement direction of the lower side brackets on the two linear structures.

The lower side bracket may include: a first elastic plate and a second elastic plate facing each other in both edge sections of the rectangular section; the first elastic plate and the second elastic plate may have the same length from the predetermined section of the rectangular section; and the first elastic plate and the second elastic plate each may have a tightener hole.

The first elastic plate and the second elastic plate each may have two beads formed in a shape of two closed hands when they go with one width away from the predetermined section of the rectangular section, and the tightener hole formed between the two beads.

The first elastic plate and the second elastic plate each may include: two beads formed in a shape of two closed hands when they go with two widths away from a predetermined section of the rectangular section; the tightener hole formed between the two beads; an elastic hole formed at a side of the tightener hole; and a pressing burring protruding toward an area between the first elastic plate and the second elastic plate from an inlet of the elastic hole.

The first elastic plate and the second elastic plate may be bent toward each other in several steps as they go away from the predetermined section of the rectangular section such that a width between the first elastic plate and the second elastic plate gradually decreases, and the first elastic plate and the second elastic plate may be closer to each other with a gap therebetween at an opposite side of the predetermined section than at the predetermined section of the rectangular section, thereby forming the open structure.

The tightener may be inserted in the tightener holes of the first elastic plate and the second elastic plate and may be thread-fastened to the first elastic plate and the second elastic plate.

The lower side bracket may include a first elastic plate and a second elastic plate facing each other in the both edge sections of the rectangular section, and a third elastic plate disposed between the first elastic plate and the second elastic plate and connecting the first elastic plate and the second elastic plate, in which the first elastic plate may be smaller in length than the second elastic plate from the predetermined section of the rectangular section, wherein the first elastic plate and the second elastic plate each may have an inner tightener hole, the third elastic plate may have the same shape as the second elastic plate at a portion, which is not in contact with the first elastic plate, as the third elastic plate goes away from the first elastic plate, and the third elastic plate may have an outer tightener hole.

The first elastic plate and the second elastic plate may respectively have beads formed in an inverse U-shape on the first elastic plate and the second elastic plate as they go with one width away from the predetermined section of the rectangular section, and the inner tightener holes respectively formed under the bead of the first elastic plate and surrounded by the bead of the second elastic plate; the first elastic plate and the third elastic plate may respectively have a coupling hole formed at the first elastic plate to receive a coupling protrusion of the third elastic plate, and the outer tightener hole formed at the third elastic plate to face the inner tightener hole of the first elastic plate when the first elastic plate and the third elastic plate are in contact with each other; and the second elastic plate and the third elastic plate may be configured such that a hook of the third elastic plate is inserted in a hook hole of the second elastic plate, so the hook of the third elastic plate may be freely rotated in the hook hole of the second elastic plate.

The first elastic plate and the second elastic plate may respectively have beads formed in an inverse U-shape on the first elastic plate and the second elastic plate as they go with two widths away from a predetermined section of the rectangular section, the inner tightener holes respectively formed under the bead of the first elastic plate and surrounded by the bead of the second elastic plate, and a pressing burring formed at an inlet of one of elastic holes formed at both sides of the inner tightener hole of the second elastic plate unlike both sides of the inner tightener hole of the first elastic plate; the first elastic plate and the third elastic plate may respectively have a coupling hole formed at the first elastic plate to receive a coupling protrusion of the third elastic plate, and the outer tightener hole formed at the third elastic plate to face the inner tightener hole of the first elastic plate when the first elastic plate and the third elastic plate are in contact with each other; and the second elastic plate and the third elastic plate may be configured such that a hook of the third elastic plate is inserted in a hook hole of the second elastic plate, so the hook of the third elastic plate may be freely rotated in the hook hole of the second elastic plate.

The second elastic plate and the third elastic plate may be bent away from each other as they go away from the predetermined section of the rectangular section to form a circular space between the second elastic plate and the third elastic plate, and each may have a pad hole and a pad seat surrounding the pad hole; and the third elastic plate may be separably coupled to the first elastic plate and rotatably coupled to the second elastic plate, thereby forming the open structure together with the first elastic plate and the second elastic plate.

The tightener may be inserted in the inner tightener holes of the first elastic plate and the second elastic plate, and the outer tightener hole of the third elastic plate, and may be thread-fastened to the first elastic plate, the second elastic plate, and the third elastic plate.

The pipe body may be rotated around the rotary pipe on the lower side bracket with the rotary pipe of the upper side bracket inserted through the connection hole of the lower side bracket.

The horizontal fastener and the vertical fastener may be inserted in the horizontal hole formed through a side of the pipe body and the vertical hole formed through another side of the pipe body, respectively, and may be thread-fastened to the pipe body, thereby pressing the square bar to the pipe body in contact with the square bar in the pipe body.

When the ceiling is a T-grid ceiling and four T-bars surrounding one rectangular area of the T-grid ceiling are provided as the linear structures, the lower side brackets may be disposed to straightly face each other or to obliquely face each other on two T-bars facing each other of the four T-bars; each may surround an upper body of an individual T-bar through the first elastic plate and the second elastic plate; and each may expose a lower body under the upper body of the individual T-bar through the open structure of the first elastic plate and the second elastic plate.

When the ceiling is a pipe ceiling and several pipes are the linear structures of the pipe ceiling, the lower side brackets may be disposed on two pipes of the several pipes to face each other straightly or obliquely, and each may surround or release an individual pipe through the open structure formed by the first elastic plate to third elastic plates.

According to the side bracket of the present disclosure, when a ceiling structure is finished in a T-grid ceiling type or a pipe ceiling type, lower side brackets are disposed on two T-bars or two pipes to face each other straightly or obliquely. Further, upper brackets are positioned in the directions in which the lower side brackets are disposed, on the two T-bars or the two pipes by rotating on the lower side brackets with respect to the lower side brackets. Accordingly, it is possible to freely determine the direction of a square bar that connects the two T-bars or the two pipes to each other on the two T-bars or the two pipes.

### BRIEF DESCRIPTION OF THE DRAWINGS

The above and other objectives, features and other advantages of the present invention will be more clearly understood from the following detailed description when taken in conjunction with the accompanying drawings, in which:

FIG. 1 shows a side bracket according to a first embodiment of the present disclosure in several side views (a left side view, a front view, and a right side view;

FIG. 2 is an exploded view of the side bracket shown in FIG. 1;

FIG. 3 is an exploded view showing a side bracket according to a second embodiment of the preset disclosure;

FIG. 4 shows a side bracket according to a third embodiment of the present disclosure in several side views (a left side view, a front view, and a right side view);

FIG. 5 is an exploded view of the side bracket shown in FIG. 4;

FIGS. 6 and 7 are images showing an open structure of a lower side bracket of the side bracket shown in FIG. 4;

FIG. 8 is an exploded view showing a side bracket according to a fourth embodiment of the preset disclosure; and

FIGS. 9 to 11 are schematic views showing a method of using the side brackets shown in FIGS. 1 to 4.

### DETAILED DESCRIPTION OF THE INVENTION

Exemplary embodiments of the present disclosure are described in detail with reference to the accompanying drawings so that those skilled in the art can easily achieve the present disclosure.

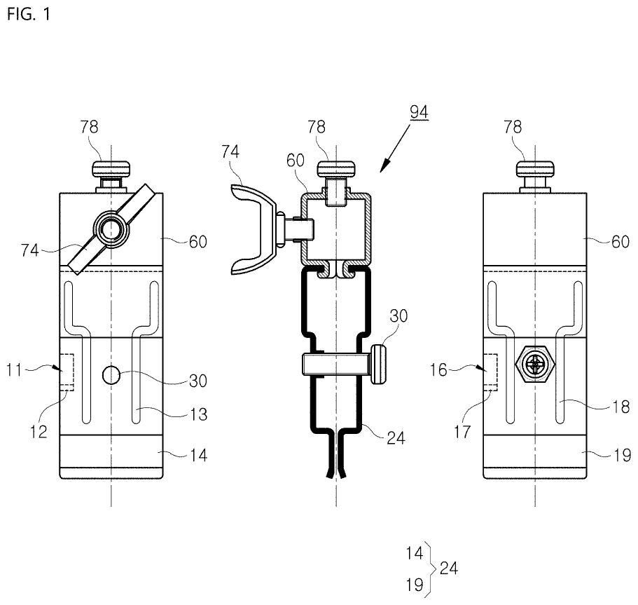

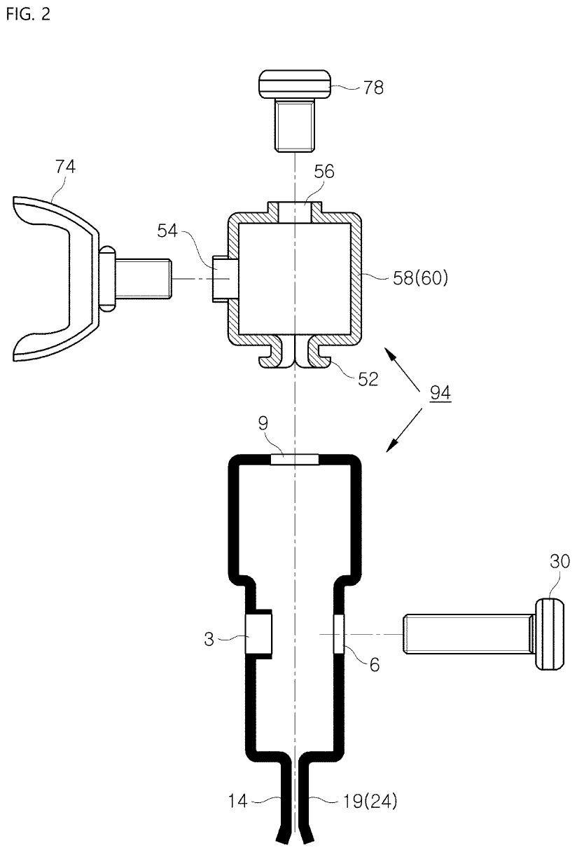

FIG. 1 shows a side bracket according to a first embodiment of the present disclosure in several side views (a left side view, a front view, and a right side view), and FIG. 2 is an exploded view of the side bracket shown in FIG. 1.

Referring to FIGS. 1 and 2, in order to stably suspend a reducer (not shown) and a sprinkler head (not shown), which are sequentially disposed from a horizontal pipe (not shown) of the ceiling of a building, from a horizontal pipe, a side bracket 94 is disposed on linear structures (214 and 218 in FIG. 1) of the ceiling and holds a square bar (224 or 228), which is combined with the reducer, across the reducer.

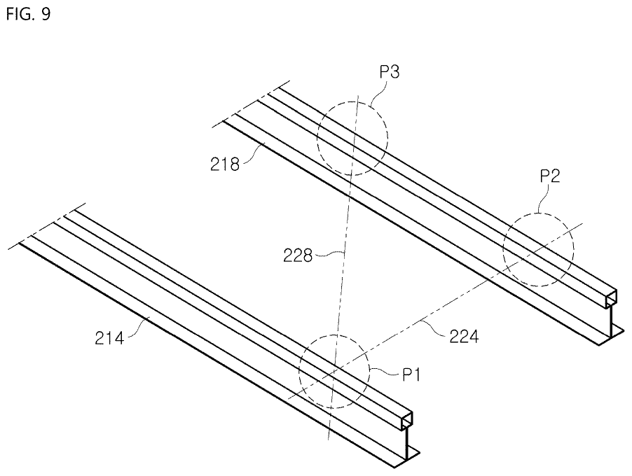

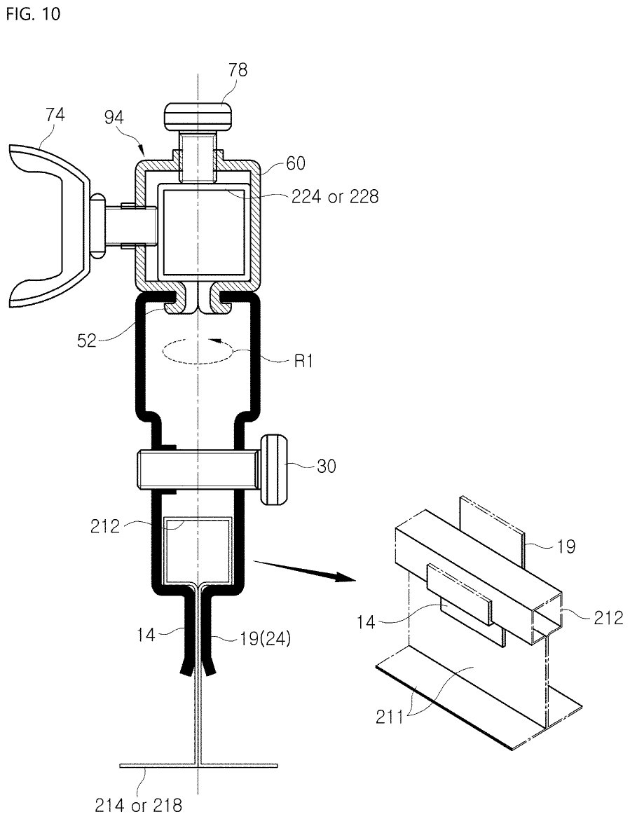

To this end, the side bracket 94 includes a lower side bracket 24, a tightener 30, an upper side bracket 60, a horizontal fastener 74, and a vertical fastener 78. Roughly speaking, the lower side bracket 24, as shown in FIGS. 9 and 10, is disposed under a square bar 224 or 228 and has an open structure (described below) formed opposite to a predetermined section of a rectangular section by bending both edge sections positioned around the predetermined section.

The tightener 30 is disposed through the lower side bracket 94 and opens/closes the open structure of the lower side bracket 94. The upper side bracket 60, as shown in FIG. 10, is a rectangular pipe, surrounds the square bar 224 or 228, and rotates on the lower side bracket 24 with respect to the predetermined section of the rectangular section. The horizontal fastener 74 and the vertical fastener 78 come in contact with the square bar 224 or 228 through a side and another side of the upper side bracket 60, respectively.

Referring to FIGS. 9 and 10, when the lower side brackets 24 are disposed on two linear structures 214 and 218 of a ceiling through the open structure, the lower side brackets 24 face each other straightly or obliquely on the two linear structures 214 and 218. Further, the upper side brackets 60 face each other on the lower side brackets 24 in the arrangement direction of the lower side brackets 24 on the two linear structures 214 and 218.

In detail, referring to FIGS. 1 and 2, the lower side bracket 24 has a connection hole (9 in FIG. 2) receiving a rotary pipe (52 in FIG. 2) of the upper side bracket 60 and guiding rotation of the rotary pipe 52 in the predetermined section of the rectangular section, and includes a first elastic plate 14 and a second elastic plate 19 facing each other in both edge sections of the rectangular section. The first elastic plate 14 and the second elastic plate 19 have the same length from the predetermined section of the rectangular section, as shown in FIG. 1 or 2.

The first elastic plate 14 and the second elastic plate 19, as shown in FIG. 1, each have two beads 13 or 18 formed in the shape of two closed hands when they go with one width away from the predetermined section of the rectangular section, and a tightener hole 3 or 6 between the two beads 13 or 18.

The first elastic plate 14 and the second elastic plate 19, as shown in FIG. 1 or 2, are bent toward each other in several steps as they go away from the predetermined section of the rectangular section such that the width between the first elastic plate 14 and the second elastic plate 19 gradually decreases. Further, the first elastic plate 14 and the second elastic plate 19 are closer to each other with a gap therebetween at the opposite side of the predetermined section than at the predetermined section of the rectangular section, thereby forming the open structure. That is, the first elastic plate 14 and the second elastic plate 19 forms a forceps-shaped open structure at the opposite side of the predetermined section of the rectangular section.

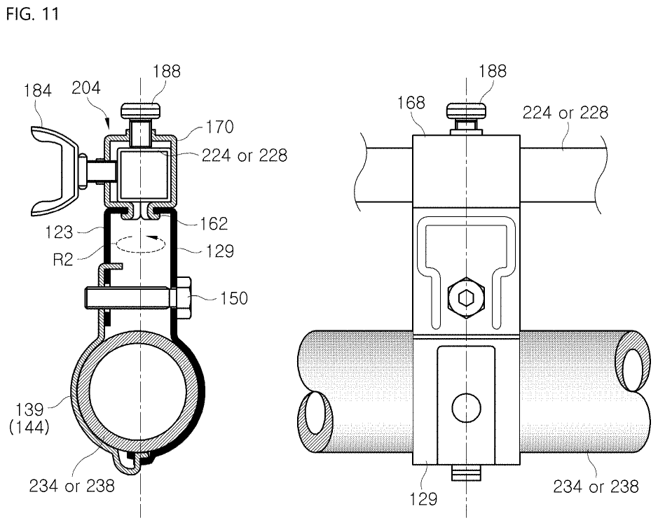

The tightener 30, referring to FIGS. 1 and 2, is inserted in the tightener hole 3 of the first elastic plate 14 and the tightener hole 6 of the second elastic plate 19 and is thread-fastened to the first elastic plate 14 and the second elastic plate 19. The upper side bracket 60, as shown in FIG. 2, has a rotary pipe 52, a horizontal hole 54, a vertical hole 56, and a pipe body 58. First, the pipe body 58, as shown in FIG. 10 or 11, is configured to surround a square bar 224 or 228 in a rectangular shape.

The rotary pipe 52, referring to FIGS. 1 and 2, is integrally formed with the pipe body 58, is inserted in the connection hole 9 of the lower side bracket 24 to be rotatably coupled to the connection hole 9 of the lower side bracket 24. The horizontal hole 54 of the pipe body 58, as shown in FIG. 2, is formed perpendicular to the rotary pipe 52 through a side of the pipe body 58, thereby communicating with the rotary pipe 52 through the inside of the pipe body 58.

The vertical hole 56 of the pipe body 58, as shown in FIG. 2, is formed through another side of the pipe body 58 to straightly face the rotary pipe 52, thereby communicating with the rotary pipe 52 through the inside of the pipe body 58. Referring to FIGS. 1 and 2, the pipe body 58 is rotated around the rotary pipe 52 (see R1 in FIG. 10) on the lower side bracket 24 with the rotary pipe 52 of the upper side bracket 60 inserted through the connection hole 9 of the lower side bracket 24.

The horizontal fastener 74 and the vertical fastener 78, referring to FIGS. 1, 2, 10, and 11, are inserted in the horizontal hole 54 formed through a side of the pipe body 58 and the vertical hole 56 formed through another side of the pipe body 58, respectively, and are thread-fastened to the pipe body 58, thereby pressing the square bar 224 or 228 to the pipe body 58 in contact with the square bar 224 or 228 in the pipe body 58.

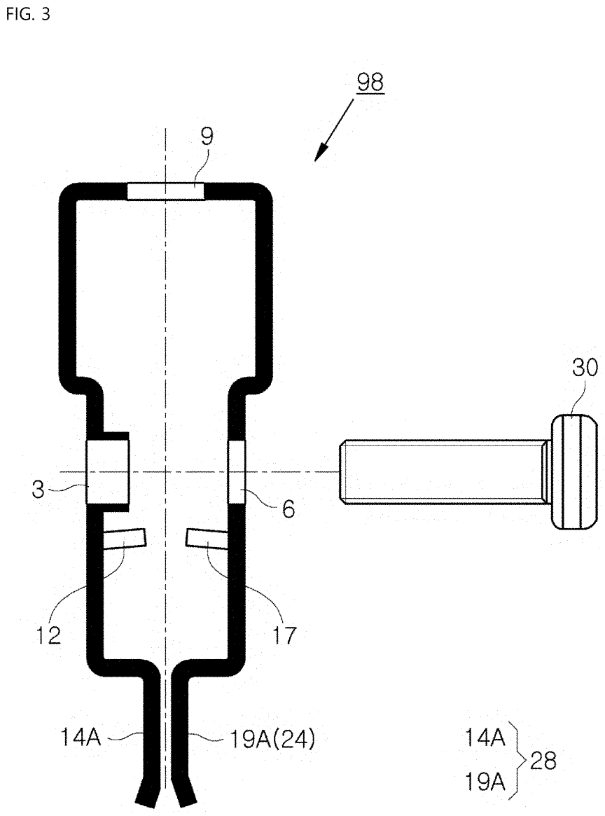

FIG. 3 is an exploded view showing a side bracket according to a second embodiment of the preset disclosure.

Referring to FIG. 3, a side bracket 98 has a similar structure to the side bracket 94 shown in FIG. 2, but the lower side bracket 28 of the side bracket 98 has a different structure from the lower side bracket 24 of the side bracket 94 shown in FIG. 2. In detail, the lower side bracket 28 also includes a first elastic plate 14A and a second elastic plate 19A facing each other in both edge sections positioned around a predetermined section of a rectangular section.

However, the first elastic plate 14A and the second elastic plate 19A each have two beads (13 or 18 in FIG. 1) formed in the shape of two closed hands when they go with two widths away from a predetermined section of the rectangular section, a tightener hole (3 or 6 in FIG. 2) between the two beads 13 or 18, an elastic hole (11 or 16 in FIG. 1) at a side of the tightener hole 3 or 6, and a pressing burring (12 or 17 in FIG. 1) protruding toward the area between the first elastic plate 14A and the second elastic plate 19A from an inlet of the elastic hole 11 or 16.

The pressing burring 12 or 17, though not shown in FIG. 10, presses the upper body 212 of a T-bar 214 or 218 between the first elastic plate 14A and the second elastic plate 19A when the tightener 30 is thread-fastened to the first elastic plate 14A and the second elastic plate 19A.

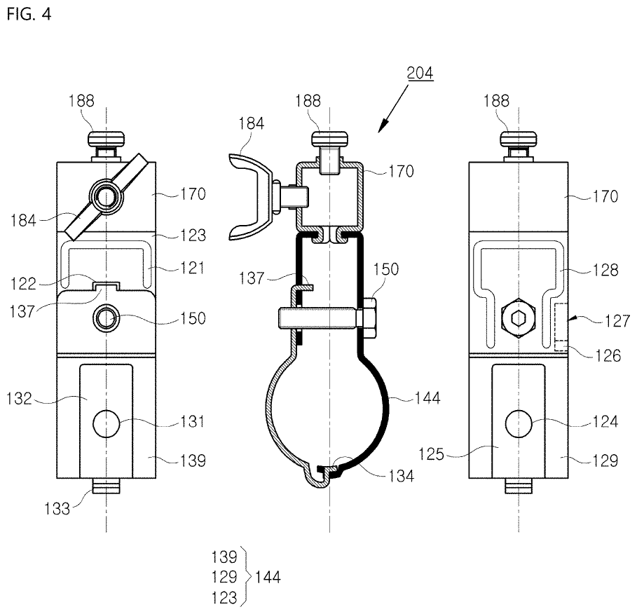

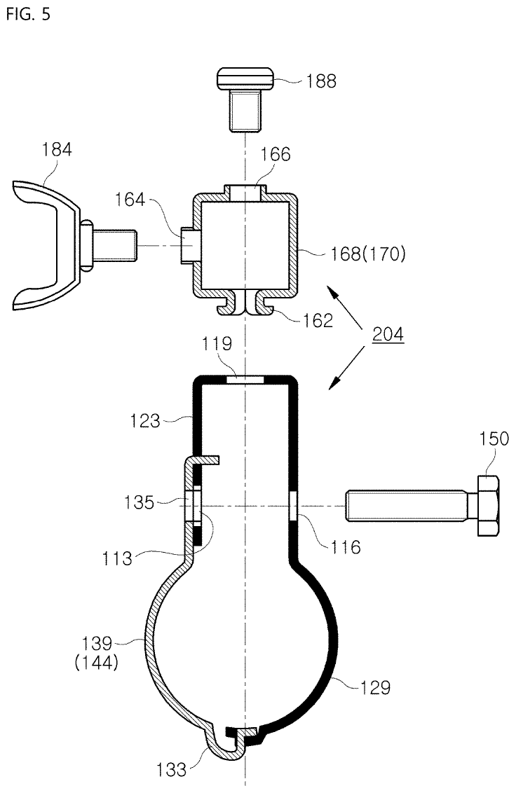

FIG. 4 shows a side bracket according to a third embodiment of the present disclosure in several side views (a left side view, a front view, and a right side view), and FIG. 5 is an exploded view of the side bracket shown in FIG. 4.

Referring to FIGS. 4 and 5, a side bracket 204 has a similar structure to the side bracket 94 shown in FIG. 1, but the lower side bracket 144 and the tightener 150 of the side bracket 204 have a different combination relationship from the lower side bracket 24 and the tightener 30 of the side bracket 94 shown in FIG. 1.

In detail, the lower side bracket 144, referring to FIGS. 4 and 5, has a connection hole 119 receiving a rotary pipe 162 of the upper side bracket 170 and guiding rotation of the rotary side bracket 162 in a predetermined section of the rectangular section.

The lower side bracket 144, as shown in FIG. 5, includes a first elastic plate 123 and a second elastic plate 129 facing each other in both edge sections of the rectangular section, and a third elastic plate 139 disposed between the first elastic plate 123 and the second elastic plate 129 and connecting the first elastic plate 123 and the second elastic plate 129.

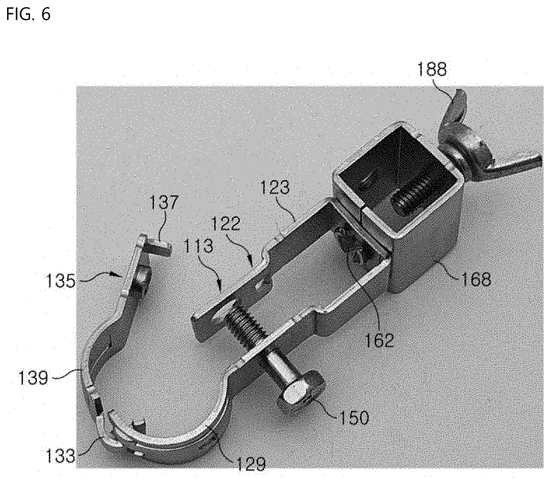

The first elastic plate 123, as shown in FIGS. 5 and 6, is smaller in length than the second elastic plate 129 from the predetermined section of the rectangular section. The third elastic plate 139, as shown in FIG. 5, has the same shape as the second elastic plate 129 at the portion, which is not in contact with the first elastic plate 123, as it goes away from the first elastic plate 123.

The first elastic plate 123 and the second elastic plate 129, as shown in FIG. 4, respectively have: beads 121 and 128 formed in an inverse U-shape on the first elastic plate 123 and the second elastic plate 129 as they go with one width away from the predetermined section of the rectangular section; and inner tightener holes 113 and 116 respectively formed under the bead 121 of the first elastic plate 123 and surrounded by the bead 128 of the second elastic plate 129.

The first elastic plate 123 and the third elastic plate 139, as shown in FIGS. 4 and 5, respectively have a coupling hole 123 formed a the first elastic plate 123 to receive a coupling protrusion 137 of the third elastic plate 139, and an outer tightener hole 135 formed at the third elastic plate 139 to face the inner tightener hole 113 of the first elastic plate 123 when the first elastic plate 123 and the third elastic plate 139 are in contact with each other.

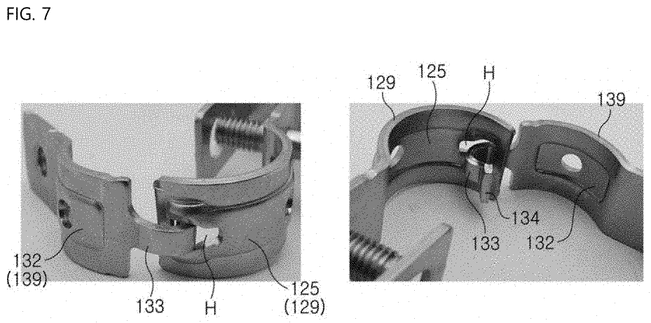

The second elastic plate 129 and the third elastic plate 139, as shown in FIGS. 5 to 7, are configured such that a hook 133, 134 of the third elastic plate 139 is inserted in a hook hole H of the second elastic plate 129. The hook 133, 134 of the third elastic plate 139 is freely rotated in the hook hole H of the second elastic plate 129.

Further, referring to FIGS. 4 and 5, the second elastic plate 129 and the third elastic plate 139 are bent away from each other as they go away from the predetermined section of the rectangular section, whereby a circular space is defined between the second elastic plate 129 and the third elastic plate 139. Further, the second elastic plate 129 and the third elastic plate 139 each have a pad hole 124 or 131 and a pad seat 125 or 132 surrounding the pad hole 124 or 131.

A rubber pad (not shown) is seated in the pad seat 125 or 132 of the second elastic plate 129 and the third elastic plate 139, thereby preventing a pipe (234 or 238 in FIG. 11) from idling over the pad seat 125 or 132. Referring to FIGS. 4 to 7, the third elastic plate 139 is separably coupled to the first elastic plate 123 and rotatably coupled to the second elastic plate 129, thereby forming an open structure together with the first elastic plate 123 and the second elastic plate 129.

That is, the third elastic plate 139 is separably coupled to the first elastic plate 123 between the first elastic plate 123 and the second elastic plate 129, thereby forming an annular open structure together with the first elastic plate 123 and the second elastic plate 129. The tightener 150, referring to FIGS. 4 to 6, is inserted in the inner tightener hole 113 of the first elastic plate 123, the inner tightener hole 116 of the second elastic plate 129, and the outer tightener hole 135 of the third elastic plate 139, and is thread-fastened to the first elastic plate 123, the second elastic plate 129, and the third elastic plate 139.

The upper side bracket 170, as shown in FIG. 5, has a rotary pipe 162, a horizontal hole 164, a vertical hole 166, and a pipe body 168. The rotary pipe 162, the horizontal hole 164, the vertical hole 166, and the pipe body 168 have the same shapes and functions as the rotary pipe 52, the horizontal hole 54, the vertical hole 56, and the pipe body 58 of the upper side bracket 60 shown in FIG. 2.

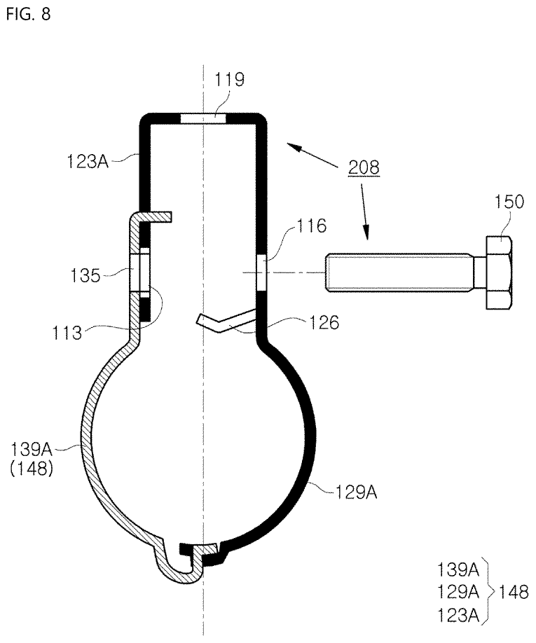

FIG. 8 is an exploded view showing a side bracket according to a fourth embodiment of the preset disclosure.

Referring to FIG. 8, a side bracket 208 has a similar structure to the side bracket 204 shown in FIG. 5, but the lower side bracket 148 of the side bracket 208 has a different structure from the lower side bracket 144 of the side bracket 204 shown in FIG. 5. Similarly, the lower side bracket 148 also has first to third elastic plates 123A, 129A, and 139A.

The first elastic plate 123A and the second elastic plate 129A respectively have: beads (121 and 128 in FIG. 4) formed in an inverse U-shape on the first elastic plate 123A and the second elastic plate 129A as they go with two widths away from a predetermined section of the rectangular section; inner tightener holes (113 and 116 in FIG. 5) respectively formed under the bead 121 of the first elastic plate 123A and surrounded by the bead 128 of the second elastic plate 129A; and a pressing burring (126 in FIG. 4 or FIG. 8) formed at an inlet of one of elastic holes (127 in FIG. 4) formed at both sides of the inner tightener hole 128 of the second elastic plate 129A unlike both sides of the inner tightener hole 113 of the first elastic plate 123A.

The pressing burring 126, though not shown in FIG. 11, presses an individual pipe 234 or 238 between the first elastic plate 123A and the second elastic plate 129A when the tightener 150 is thread-fastened to the first elastic plate 123A, the second elastic plate 129A, and the third elastic plate 139A.

The first elastic plate 123A and the third elastic plate 139A respectively have: a coupling hole (122 in FIG. 4) for receiving a coupling protrusion (137 in FIG. 4) of the third elastic plate 139A inside the first elastic plate 123A, and an outer tightener hole 135 formed through the third elastic plate 139A to face the inner tightener hole 113 of the first elastic plate 123 when the first elastic plate 123A and the third elastic plate 139A are in contact with each other.

The second elastic plate 129A and the third elastic plate 139A are configured such that a hook 133, 134 of the third elastic plate 139A is inserted in a hook hole H of the second elastic plate 129A. The hook 133, 134 of the third elastic plate 139A is freely rotated in the hook hole H of the second elastic plate 129A.

FIGS. 9 to 11 are schematic views showing a method of using the side brackets shown in FIGS. 1 to 4.

Referring to FIGS. 9 and 10, the side bracket 94 shown in FIG. 1 may be prepared. The side bracket 94 includes the lower side bracket 24, the tightener 30, the upper side bracket 60, the horizontal fastener 74, and the vertical fastener 78. The lower side bracket 24, the tightener 30, the upper side bracket 60, the horizontal fastener 74, and the vertical fastener 78 were sufficiently described with reference to FIGS. 1 and 2.

When the ceiling of a building is a T-grid ceiling and four T-bars surrounding one rectangular area of the T-grid ceiling are provided as linear structures (described with reference to FIGS. 1 and 2), the lower side brackets 24 may be disposed at seat positions P1 and P2 to straightly face each other or at seat positions P1 and P3 to obliquely face each other on two T-bars 214 and 218 facing each other of the four T-bars.

In this case, the lower side bracket 24 can surround the upper body 212 of the individual T-bar 214 or 218 through the first elastic plate 14 and the second elastic plate 19, and the lower body 211 under the upper body 212 of the individual T-bar 214 or 218 can be exposed through the open structure of the first elastic plate 14 and the second elastic plate 19. Next, the tightener 30 may be put through the first elastic plate 14 and the second elastic plate 19.

The tightener 30 is thread-fastened to the first elastic plate 14 and the second elastic plate 19, thereby increasing or decreasing the width between the first elastic plate 14 and the second elastic plate 19. Next, the upper side bracket 60 is placed on the lower side bracket 24 and can be rotated (R1) with respect to the lower side bracket 24 through the rotary pipe 52. The rotation (R1) of the upper side bracket 60 is performed to align the upper side bracket 60 with the lower side bracket 24.

Next, a square bar 224 or 228 may be put through the upper side bracket 60 on the individual T-bar 214 or 218. Next, the square bar 224 or 228 may be fixed inside the upper side bracket 60 by the horizontal fastener 74 and the vertical fastener 78 tightened through the upper side bracket 60. Accordingly, the square bar 224 or 228, as shown in FIG. 9, can be positioned perpendicularly or obliquely to the two T-bars 214 and 218.

Referring to FIGS. 9 and 11, the side bracket 204 shown in FIG. 4 may be prepared. The side bracket 204 includes the lower side bracket 144, the tightener 150, the upper side bracket 170, the horizontal fastener 184, and the vertical fastener 188. The lower side bracket 144, the tightener 150, the upper side bracket 170, the horizontal fastener 184, and the vertical fastener 188 were sufficiently described with reference to FIGS. 4 to 7.

When the ceiling of a building is a pipe ceiling and several pipes are linear structures of the pipe ceiling, the lower side brackets 144 may be disposed on two pipes 234 and 238 of the several pipes to face each other straightly or obliquely. It is assumed that the two pipes 234 and 238 replace the two T-bars 214 and 218 shown in FIG. 9.

The lower side bracket 144 can surround or release an individual pipe 234 through the open structure formed by the first to third elastic plates 123, 129, and 139. This is because the third elastic plate 139 is rotatably coupled to the second elastic plate 129 and separably coupled to the first elastic plate 123. Next, the tightener 150 may be put through the first elastic plate 123, the second elastic plate 129, and the third elastic plate 139.

The tightener 150 is thread-fastened to the first elastic plate 123, the second elastic plate 129, and the third elastic plate 139, thereby increasing or decreasing the width between the first elastic plate 123 and the second elastic plate 129. Next, the upper side bracket 170 is placed on the lower side bracket 144 and can be rotated (R2) with respect to the lower side bracket 144 through the rotary pipe 162. The rotation (R2) of the upper side bracket 170 is performed to align the upper side bracket 170 with the lower side bracket 144.

Next, a square bar 224 or 228 may be put through the upper side bracket 170 on the individual pipe 234 or 238. Next, the square bar 224 or 228 may be fixed inside the upper side bracket 170 by the horizontal fastener 184 and the vertical fastener 188 tightened through the upper side bracket 170. Accordingly, the square bar 224 or 228 can be positioned perpendicularly or obliquely to the two pipes 234 and 238.

What is claimed is:

1. A side bracket that is disposed on linear structures of a ceiling of a building and holds a square bar, which is combined with a reducer, across the reducer to stably suspend the reducer and a sprinkler head, which are sequentially disposed from a horizontal pipe of the ceiling, from the horizontal pipe, the side bracket comprising:
a lower side bracket disposed under the square bar and having an open structure formed opposite to a predetermined section of a rectangular section by bending both edge sections positioned around the predetermined section;
a tightener disposed through the lower side bracket and opening or closing the open structure of the lower side bracket;
an upper side bracket being formed as a rectangular pipe, surrounding the square bar, and rotating on the lower side bracket with respect to the predetermined section of the rectangular section; and
a horizontal fastener and a vertical fastener being in contact with the square bar through a side and another side of the upper side bracket, respectively,
wherein, when the lower side brackets are disposed on two linear of the ceiling through the open structure, the lower side brackets face each other straightly or obliquely on the two linear structures, with a connection hole formed at the predetermined section of the rectangular section, and
the upper side bracket comprises:
a pipe body configured to surround the square bar in a rectangular shape,
a rotary pipe integrally formed with the pipe body, inserted in the connection hole of the lower side bracket to be rotatably coupled to the connection hole of the lower side bracket,
a horizontal hole formed perpendicular to the rotary pipe through a side of the pipe body and communicating with the rotary pipe through an inside of the pipe body, and
a vertical hole formed through another side of the pipe body to straightly face the rotary pipe and communicating with the rotary pipe through the inside of the pipe body,
wherein the upper side brackets face each other on the lower side brackets in an arrangement direction of the lower side brackets on the two linear structures.

2. The side bracket of claim 1, wherein the lower side bracket comprises a first elastic plate and a second elastic plate facing each other in both edge sections of the rectangular section,
wherein the first elastic plate and the second elastic plate have the same length from the predetermined section of the rectangular section, and
the first elastic plate and the second elastic plate each have a tightener hole.

3. The side bracket of claim 2, wherein the first elastic plate and the second elastic plate each comprise: two beads formed in a shape of two closed hands when they go with one width away from the predetermined section of the rectangular section, and the tightener hole formed between the two beads.

4. The side bracket of claim 2, wherein the first elastic plate and the second elastic plate each comprise: two beads formed in a shape of two closed hands when they go with two widths away from a predetermined section of the rectangular section; the tightener hole formed between the two beads; an elastic hole formed at a side of the tightener hole; and a pressing burring protruding toward an area between the first elastic plate and the second elastic plate from an inlet of the elastic hole.

5. The side bracket of claim 2, wherein the first elastic plate and the second elastic plate are bent toward each other in several steps as they go away from the predetermined section of the rectangular section such that a width between the first elastic plate and the second elastic plate gradually decreases, and the first elastic plate and the second elastic plate are closer to each other with a gap therebetween at an opposite side of the predetermined section than at the predetermined section of the rectangular section, thereby forming the open structure.

6. The side bracket of claim 2, wherein the tightener is inserted in the tightener holes of the first elastic plate and the second elastic plate and is thread-fastened to the first elastic plate and the second elastic plate.

7. The side bracket of claim 1, wherein the lower side bracket comprises a first elastic plate and a second elastic plate facing each other in the both edge sections of the rectangular section, and a third elastic plate disposed between the first elastic plate and the second elastic plate and connecting the first elastic plate and the second elastic plate,
wherein the first elastic plate is smaller in length than the second elastic plate from the predetermined section of the rectangular section,
the first elastic plate and the second elastic plate each have an inner tightener hole,
the third elastic plate has the same shape as the second elastic plate at a portion, which is not in contact with the first elastic plate, as the third elastic plate goes away from the first elastic plate, and
the third elastic plate has an outer tightener hole.

8. The side bracket of claim 7, wherein the first elastic plate and the second elastic plate respectively comprise: beads formed in an inverse U-shape on the first elastic plate and the second elastic plate as they go with one width away from the predetermined section of the rectangular section; and the inner tightener holes respectively formed under the bead of the first elastic plate and surrounded by the bead of the second elastic plate,
the first elastic plate and the third elastic plate respectively comprise a coupling hole formed at the first elastic plate to receive a coupling protrusion of the third elastic plate, and the outer tightener hole formed at the third elastic plate to face the inner tightener hole of the first elastic plate when the first elastic plate and the third elastic plate are in contact with each other, and
the second elastic plate and the third elastic plate are configured such that a hook of the third elastic plate is inserted in a hook hole of the second elastic plate, so the hook of the third elastic plate is freely rotated in the hook hole of the second elastic plate.

9. The side bracket of claim 7, wherein the first elastic plate and the second elastic plate respectively comprise: beads formed in an inverse U-shape on the first elastic plate and the second elastic plate as they go with two widths away from a predetermined section of the rectangular section;
the inner tightener holes respectively formed under the bead of the first elastic plate and surrounded by the bead of the second elastic plate; and
a pressing burring formed at an inlet of one of elastic holes formed at both sides of the inner tightener hole of the second elastic plate unlike both sides of the inner tightener hole of the first elastic plate,
the first elastic plate and the third elastic plate respectively comprise a coupling hole formed at the first elastic plate to receive a coupling protrusion of the third elastic plate, and the outer tightener hole formed at the third elastic plate to face the inner tightener hole of the first elastic plate when the first elastic plate and the third elastic plate are in contact with each other, and
the second elastic plate and the third elastic plate are configured such that a hook of the third elastic plate is inserted in a hook hole of the second elastic plate, so the hook of the third elastic plate is freely rotated in the hook hole of the second elastic plate.

10. The side bracket of claim 7, wherein the second elastic plate and the third elastic plate are bent away from each other as they go away from the predetermined section of the rectangular section to form a circular space between the second elastic plate and the third elastic plate, and each comprise a pad hole and a pad seat surrounding the pad hole; and
the third elastic plate is separably coupled to the first elastic plate and rotatably coupled to the second elastic plate, thereby forming the open structure together with the first elastic plate and the second elastic plate.

11. The side bracket of claim 7, wherein the tightener is inserted in the inner tightener holes of the first elastic plate and the second elastic plate, and the outer tightener hole of the third elastic plate, and is thread-fastened to the first elastic plate, the second elastic plate, and the third elastic plate.

12. The side bracket of claim 1, wherein the pipe body is rotated around the rotary pipe on the lower side bracket with the rotary pipe of the upper side bracket inserted through the connection hole of the lower side bracket.

13. The side bracket of claim 12, wherein the horizontal fastener and the vertical fastener are inserted in the horizontal hole formed through a side of the pipe body and the vertical hole formed through another side of the pipe body, respectively, and are thread-fastened to the pipe body, thereby pressing the square bar to the pipe body in contact with the square bar in the pipe body.

14. The side bracket of claim 5, wherein when the ceiling is a T-grid ceiling and four T-bars surrounding one rectangular area of the T-grid ceiling are provided as the linear structures,
the lower side brackets are disposed to straightly face each other or to obliquely face each other on two T-bars facing each other of the four T-bars,
each surround an upper body of an individual T-bar through the first elastic plate and the second elastic plate, and
each expose a lower body under the upper body of the individual T-bar through the open structure of the first elastic plate and the second elastic plate.

15. The side bracket of claim 7, wherein when the ceiling is a pipe ceiling and several pipes are the linear structures of the pipe ceiling,
the lower side brackets are disposed on two pipes of the several pipes to face each other straightly or obliquely, and
each surround or release an individual pipe through the open structure formed by the first elastic plate to third elastic plates.
